(19) United States
(12) Patent Application Publication
(10) Pub. No.: US 2019/0140226 A1
(43) Pub. Date: May 9, 2019

(54) HANDLE AND LATCHING MECHANISM FOR A REMOVABLE BATTERY

(71) Applicant: West Affum Holdings Corp., Grand Cayman (KY)

(72) Inventors: Quan Hoang Nguyen, Renton, WA (US); Robert Reuben Buchanan, Bothell, WA (US); Dallas Eugene Meeker, Kirkland, WA (US); Daniel James Finney, Woodinville, WA (US); Sena Janky, Sammamish, WA (US)

(21) Appl. No.: 16/186,368

(22) Filed: Nov. 9, 2018

Related U.S. Application Data
(60) Provisional application No. 62/584,016, filed on Nov. 9, 2017.

(51) Int. Cl. H01M 2/10

(52) U.S. Cl. CPC H01M 2/1022; H01M 2220/30

(57) ABSTRACT

A rotating battery handle design is disclosed along with various means and mechanisms for latching the battery into an electronics enclosure. This disclosure provides a secure latching method with improved ergonomics for elderly patients.

### CROSS-REFERENCE(S) TO RELATED APPLICATION(S)

This application which claims priority to and the benefit of U.S. Provisional Patent Application No. 62/584,016, filed Nov. 9, 2017, the contents of which are hereby incorporated by reference in their entirety for all purposes.

### BACKGROUND

A rotating battery handle design is disclosed along with various means and mechanisms for latching the battery into an electronics enclosure. This disclosure provides a secure latching method with improved ergonomics for elderly patients.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a first perspective view of a Handle and Latching Mechanism for a Removable Battery.

FIG. 2 is a front orthogonal view of a Handle and Latching Mechanism for a Removable Battery.

FIG. 3 is a rear orthogonal view of a Handle and Latching Mechanism for a Removable Battery.

FIG. 4 is a top orthogonal view of a Handle and Latching Mechanism for a Removable Battery.

FIG. 5 is a bottom orthogonal view of a Handle and Latching Mechanism for a Removable Battery.

FIG. 6 is a right orthogonal view of a Handle and Latching Mechanism for a Removable Battery.

FIG. 7 is a left orthogonal view of a Handle and Latching Mechanism for a Removable Battery.

FIG. 8 is a second perspective view of a Handle and Latching Mechanism for a Removable Battery.

FIG. 9 is a third perspective view of a Handle and Latching Mechanism for a Removable Battery having the Handle portion extended.

FIG. 10 illustrates one illustrative embodiment of a Handle and Latching Mechanism for a Removable Battery.

FIG. 11 illustrates another illustrative embodiment of a Handle and Latching Mechanism for a Removable Battery.

FIG. 12 illustrates yet another illustrative embodiment of a Handle and Latching Mechanism for a Removable Battery.

FIG. 13 illustrates still another illustrative embodiment of a Handle and Latching Mechanism for a Removable Battery.

FIG. 14 illustrates yet still another illustrative embodiment of a Handle and Latching Mechanism for a Removable Battery.

FIG. 15 illustrates yet still another illustrative embodiment of a Handle and Latching Mechanism for a Removable Battery.

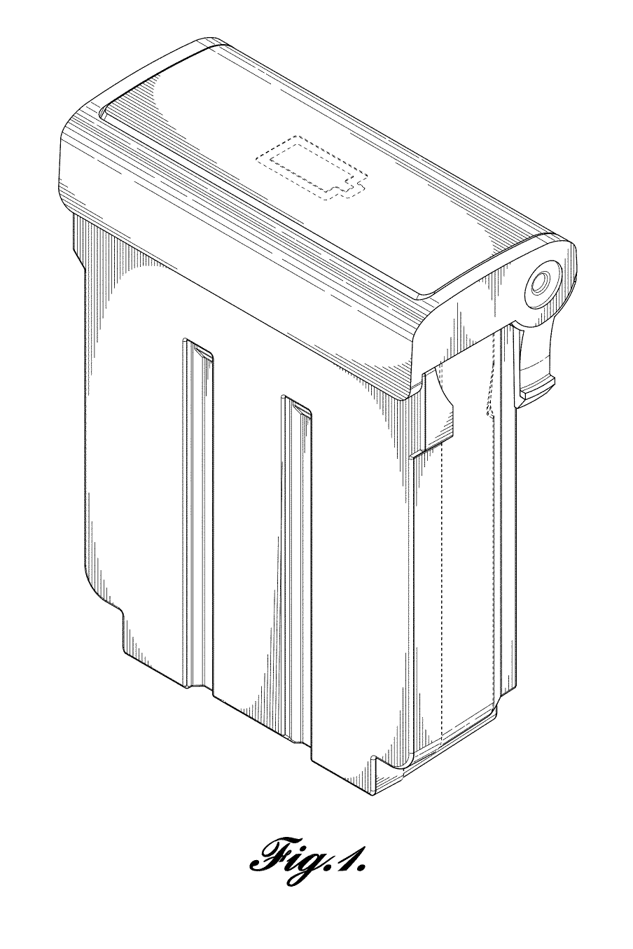

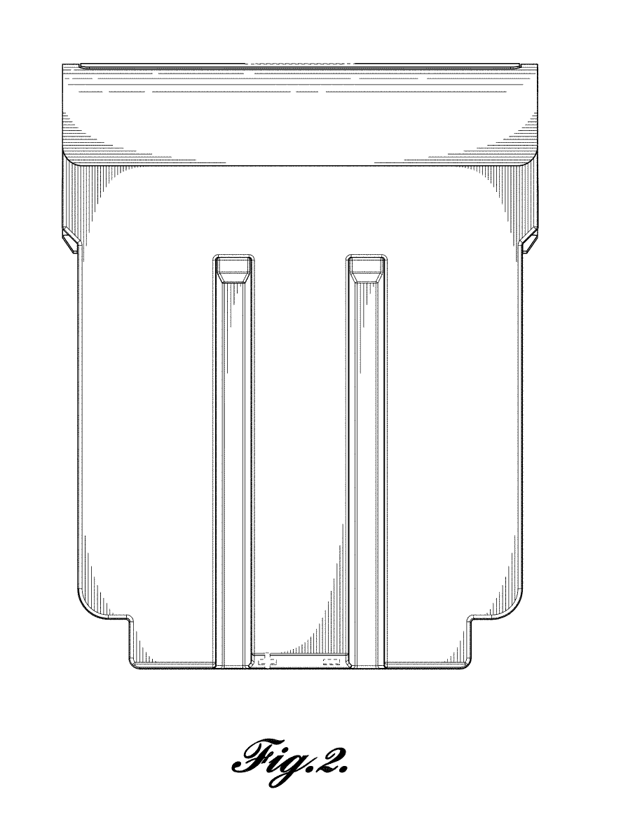

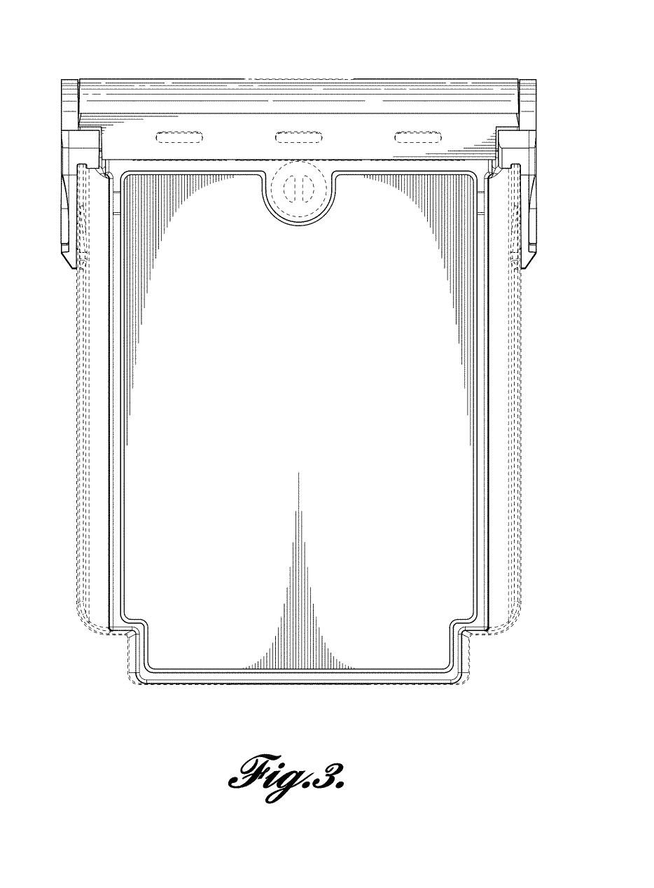

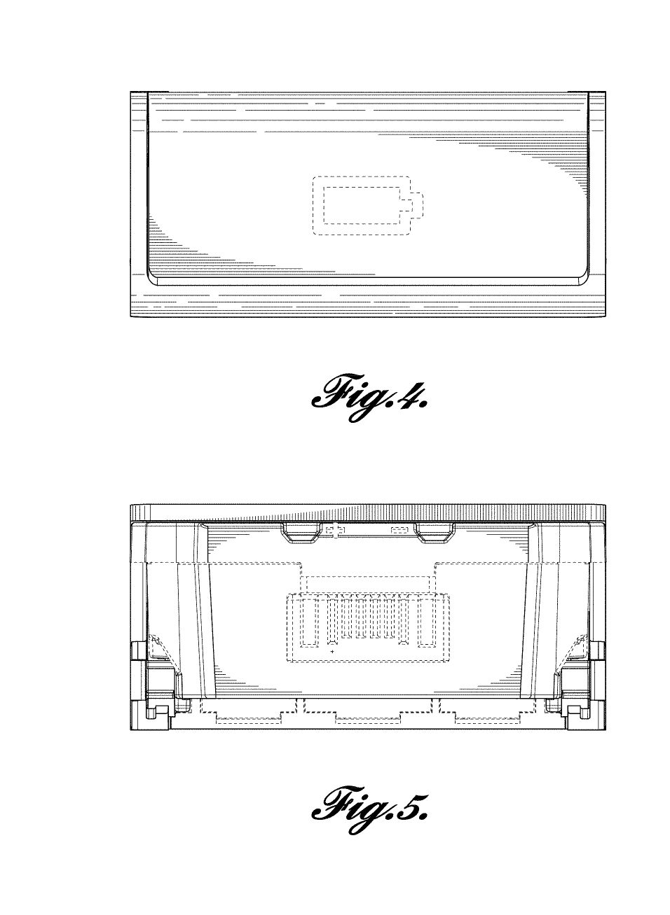

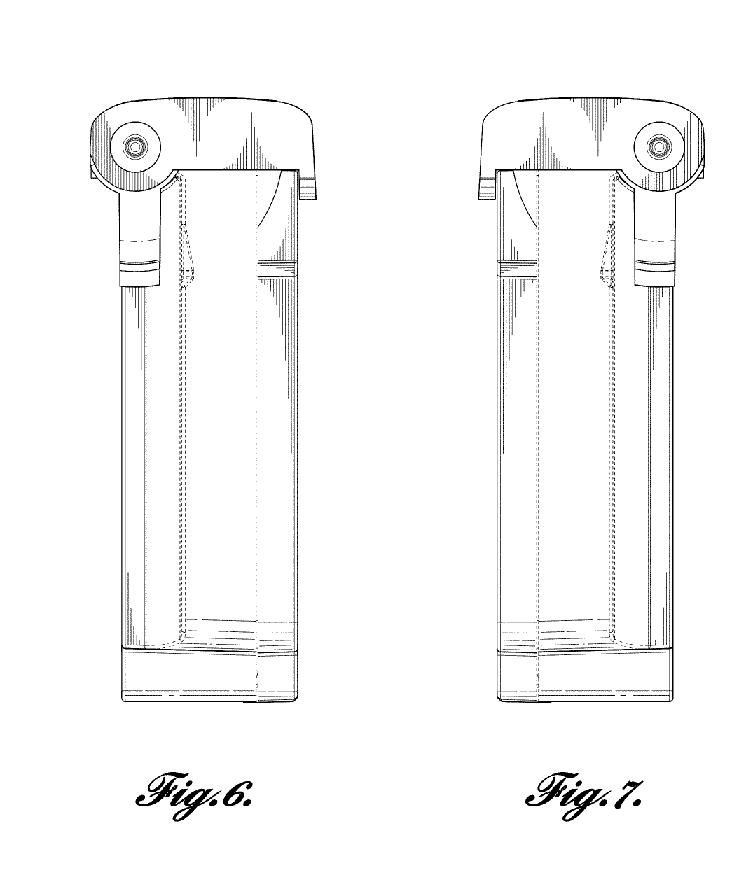

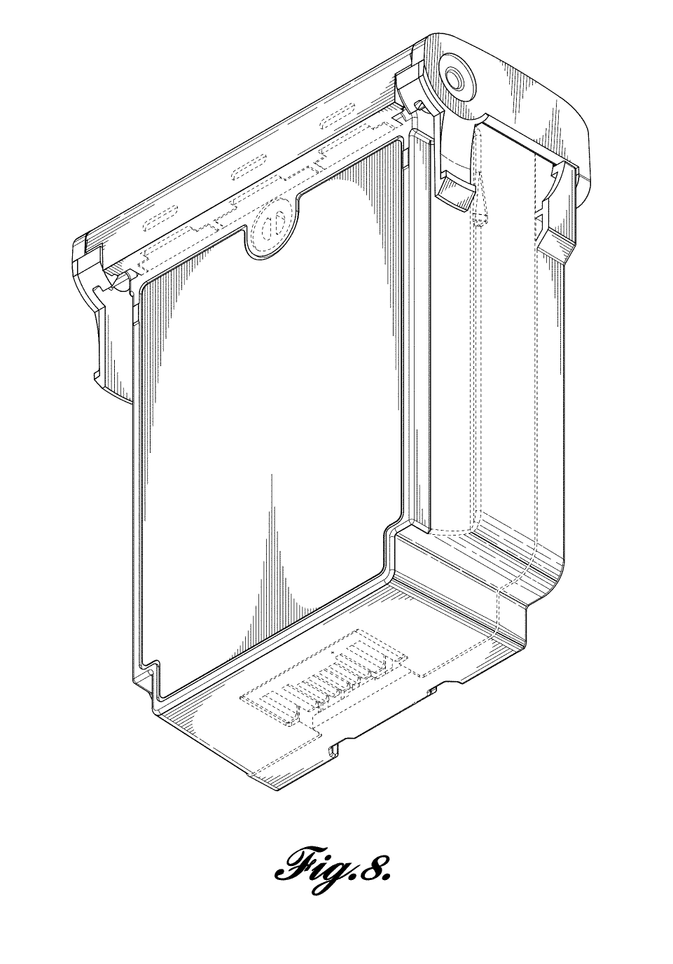

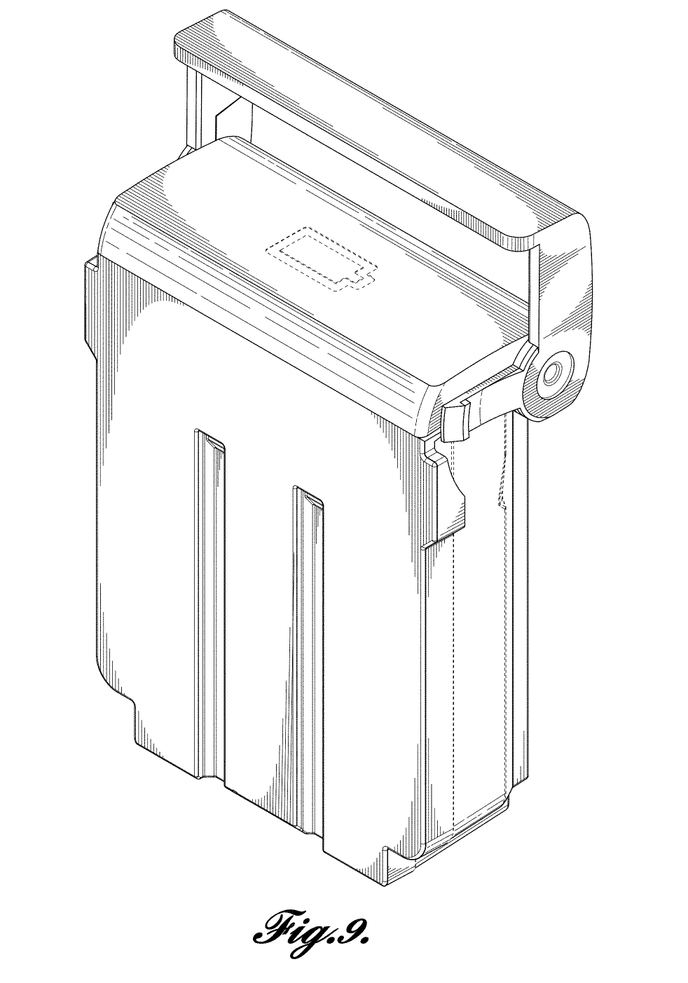

### DETAILED DESCRIPTION

While illustrative embodiments have been illustrated and described, it will be appreciated that various changes can be made therein without departing from the spirit and scope of the disclosure.

The Blazer product is a Wearable Cardioverter Defibrillator designed for a patient population who typically have age related difficulties such as arthritis, degraded vision and reduced dexterity. The WCD may require them to remove and replace its rechargeable battery on a daily basis. It is desired that this removal and re-insertion task be obvious and easy for patients with these dexterity difficulties, yet the battery latch needs to engage very securely and should not come disengaged if the electronics are dropped or if the patient collapses while suffering a Sudden Cardiac Arrest.

Implementations of WCD use a secure two button latching mechanism which is difficult to disengage and many patients are known to require assistance from another person to remove and replace their batteries. Another implementation uses a single button which likely improves patient ability to disengage the latch, but is still less than ideal and may reduce the ruggedness of the battery retention in drop, impact and fall conditions.

Latch Handle

This disclosure uses a handle incorporated into the battery pack to allow a patient to quickly and easily locate the battery latch and disengage it to remove the battery for replacement. Several different varieties of handle are envisioned, but most embodiments incorporate a pivot with a ring shaped handle piece which is rotated away from the electronics enclosure to disengage a latch.

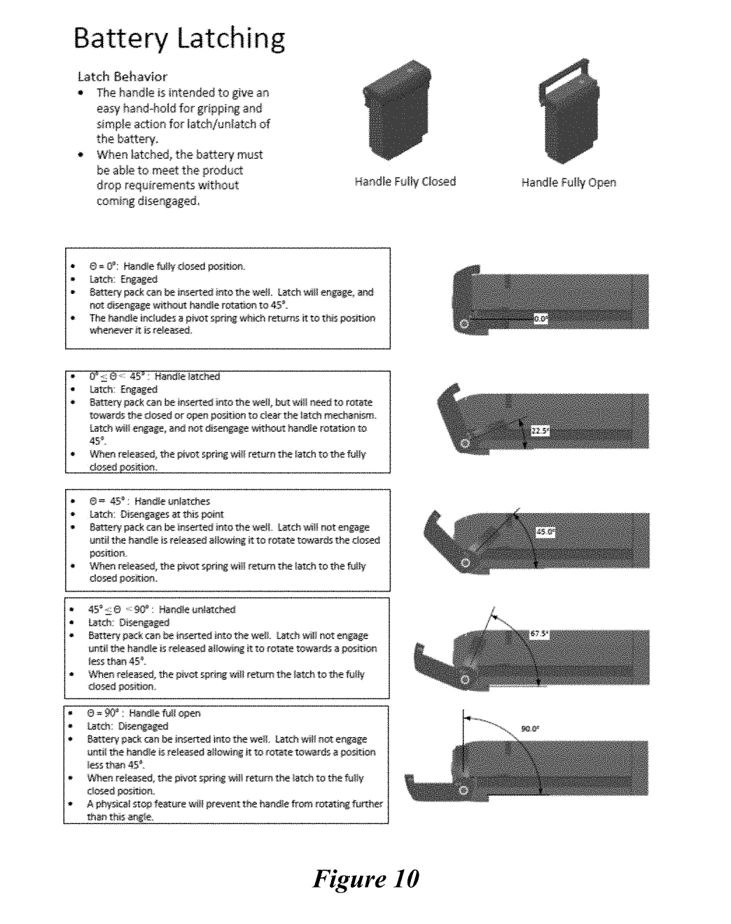

FIG. 10 illustrates and summarizes how one embodiment of a battery latch is envisioned to operate when activated by the handle and removed or inserted into the main electronics housing.

Rotary Snap Latch

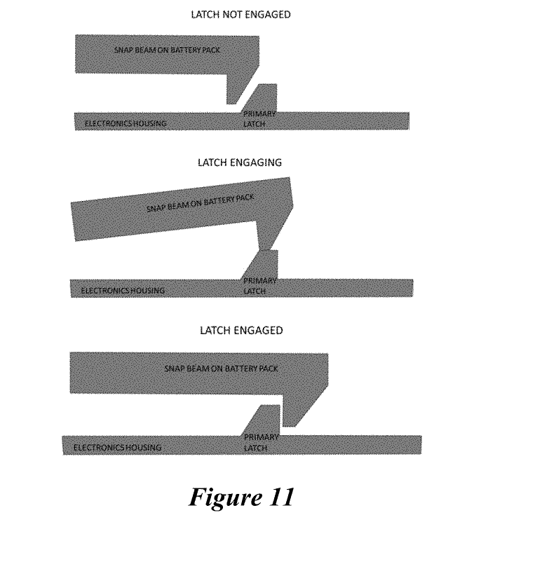

FIG. 11 illustrates another embodiment of latch that uses a snap beam that latches over a ramp in the enclosure when the handle is in the closed position. As long as the handle remains in the closed position (or less than a given angle, such as, for example, 45 degrees), the latch will prevent the battery from being removed. When the handle is rotated to the given angle, the snap beam rotates away from the enclosures ramp and releases the battery. The battery retention with the handle closed is achieved by the stiffness of the snap beam in the first implementation. Using just the beam stiffness for retention can require a stiff beam which may make the battery difficult to insert and impart high stresses into the latch features.

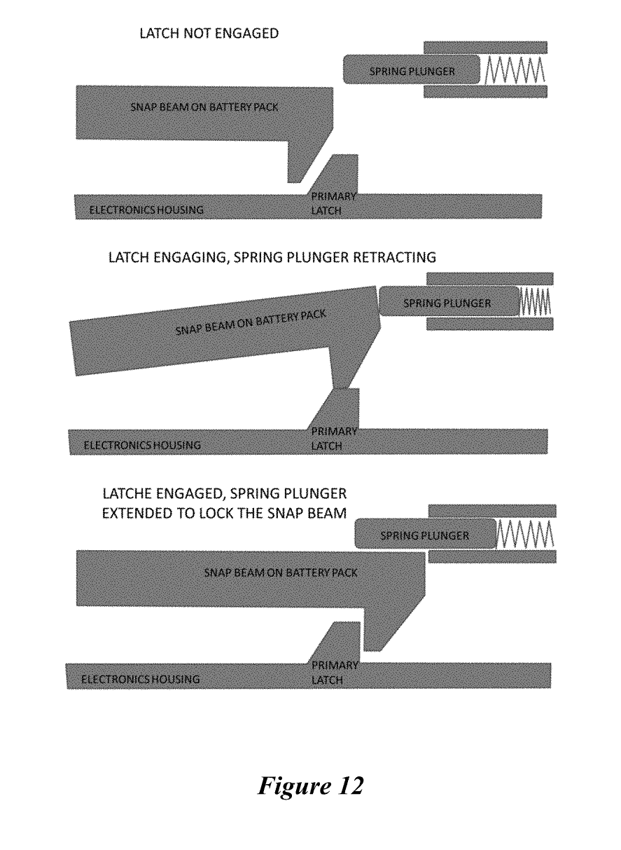

FIG. 12 illustrates another alternate implementation uses a secondary back latch to hold the snap beam in a latch position until the handle is rotated. This back latch can be a spring plunger which slides back during battery insertion and springs back behind the snap beam once the primary latch is cleared.

Linkage and Slider

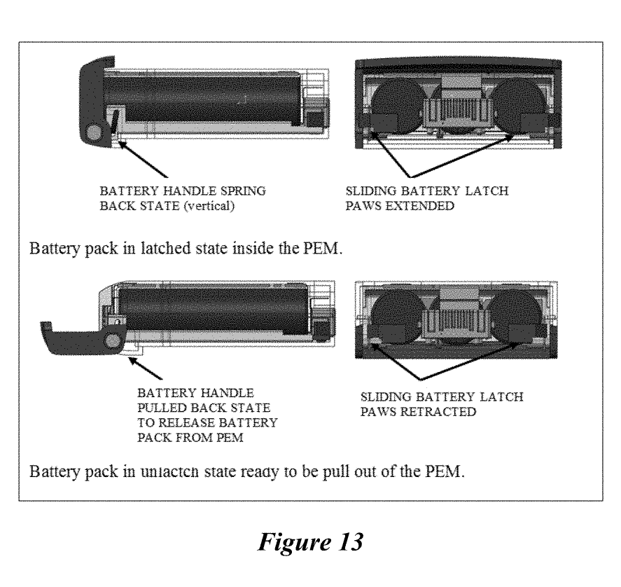

FIG. 13 illustrates yet another embodiment that utilizes the battery handle motion, through a linkage, converts rotation to linear motion which drive the latch paws, housed inside the battery, in and out unlatching or latching the battery inside the PEM. The PEM would have pockets, sufficiently deep, to keep the battery latched to the PEM. Below figure captured a representative mechanism discussed for this latching method.

As shown in FIG. 13, the battery could be unlatched by rotating the battery handle back approximately 45 to 60 degrees from vertical, retracting the latch paws pass the PEM pockets (not shown), as the handle continue to rotate 90 degree from vertical, the battery could be released from the PEM with minimal pull force on the handle. Once the force on the handle is removed, a single or multiple torsional or compression springs return the handle to the vertical state, which extend the latch paws outside of the battery pack, in turn allow the battery to be insert back inside the PEM. The latch paws spring back could be accomplish, with a spring mounted to each latch or combine with the handle moment, to achieve the same result.

Pulley and Slider

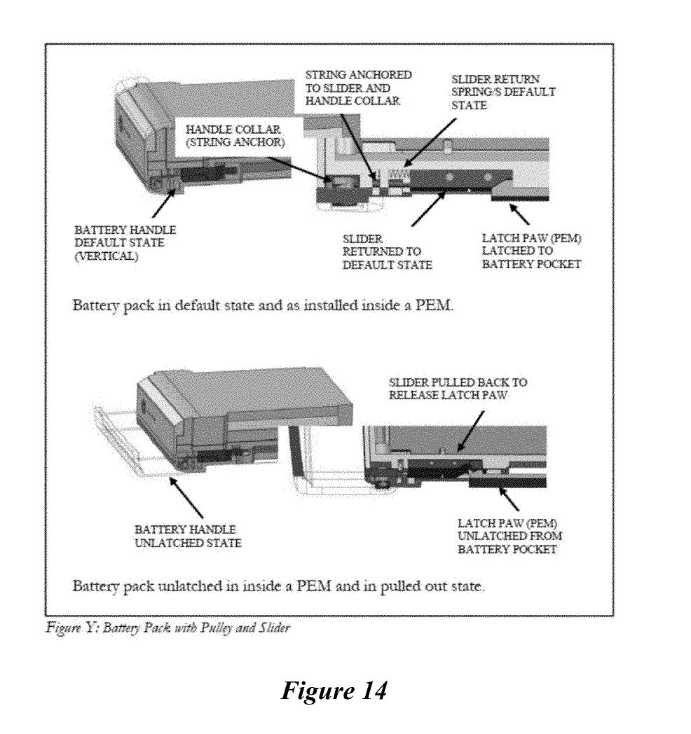

Yet another embodiment, shown in FIG. 14, uses the battery handle motion to release the battery pack from the PEM. Instead of a rigid linkage, as with previous method, a string anchored to the handle and sliding member is used to release latch paws which reside on the PEM. The latch paws, individually spring loaded or incorporated into a deflection beams, latched into pockets on the battery pack when the battery pack is installed. To release the battery the slider, one on each side of the battery, would need to slide pass the latch paw, pushing the latch paw out of the battery pocket. This is accomplished by rotating the handle pass 45 degree, wrapping the string on the handle mandrel, pulling the slider back far enough to start pushing on the latch paw. As the handle continue to rotate to 90 degree the slider is pulled back far enough to push the latch paw outside of the pocket. At this point the battery could be removed from the PEM with minimal pull force. FIG. 14 illustrates one embodiment of such a mechanism discussed above.

Cylindrical CAM and Rocker Arm

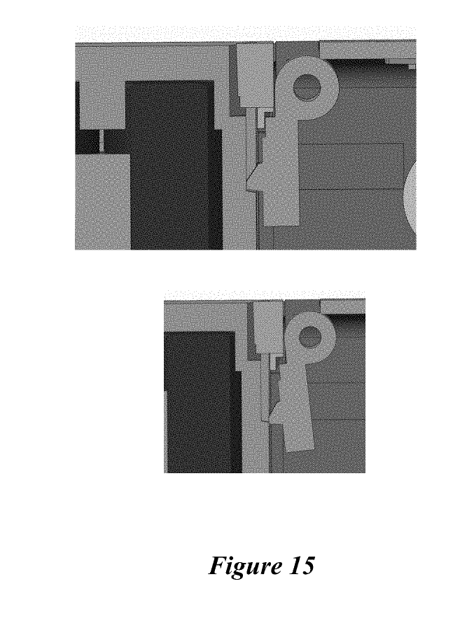

FIG. 15 illustrates an embodiment similar to the mechanism discussed for the “Rotary Snap Latch”. This embodiment uses a molded cylindrical cam on each side of the battery handle as actuators to push latch paws, reside on the PEM, to unlatch the battery pack from the PEM. The figure below captured the design intent for this mechanism. The latch paws resided on the PEM would be spring loaded against the battery handle with traditional compression or torsional springs or flex members on the PEM or on the latch paw themselves.

Other embodiments include combinations and sub-combinations of features described or shown in the drawings herein, including for example, embodiments that are equivalent to: providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, feature or features can refer to the structures and/or functions of an apparatus, article of manufacture or system, and/or the steps, acts, or modalities of a method.

The embodiments of the disclosure in which an exclusive property or privilege is claimed are defined as follows:

1. A rotating battery handle design, comprising a secure latching method with improved ergonomics for elderly patients.
